(19) United States
(12) Patent Application Publication
(10) Pub. No.: US 2026/0326177 A1
(43) Pub. Date: Oct. 22, 2026

(54) Method and system for the alkaline-thermal degradation at ambient pressure of perfluoroalkyl and polyfluoroalkyl substances present in polluted soil

(71) Applicant: ORTEC GENERALE DE DEPOLLUTION, AIX-EN-PROVENCE (FR)

(72) Inventors: Christophe CHENE, Genas (FR); Clotilde JOHANSSON, Lyon (FR)

(73) Assignee: ORTEC GENERALE DE DEPOLLUTION, AIX-EN-PROVENCE (FR)

(21) Appl. No.: 19/336,912

(22) Filed: Sep. 23, 2025

(30) Foreign Application Priority Data
Sep. 30, 2024 (FR) 2410495

(51) Int. Cl. B09C 1/06; B09C 1/00; B09C 1/08

(52) U.S. Cl. CPC B09C 1/062; B09C 1/005; B09C 1/08; B09C 2101/00

(57) ABSTRACT

A method and system for the alkaline-thermal degradation at ambient pressure of perfluoroalkyl and polyfluoroalkyl substances present in the polluted soil.

The method (P) for the alkaline-thermal degradation of PFAS substances comprises in particular an incorporation step (E1) for incorporating an alkaline compound and optionally an adjuvant into the polluted soil, a heating step (E2) for heating the polluted soil comprising the alkaline compound and the adjuvant to a degradation temperature of between 100 °C and 290 °C, the heating step (E2) being carried out at ambient pressure, and an extraction step (E3) for extracting the gases generated during the heating step (E2), and preferably a step for treating the extracted gases (E4), this method (P) allows PFAS substances to be degraded on a large scale, at low cost, and in a relatively simple and highly effective manner.

### TECHNICAL FIELD

The present invention concerns a method and a system for the alkaline-thermal degradation of perfluoroalkyl and polyfluoroalkyl substances present in polluted soil.

### PRIOR ART

We know that per- and polyfluoroalkyl substances (PFAS), also known as “eternal pollutants”, are highly stable and mobile in the environment, so they can cause widespread contamination on a global scale. The impact of some of these PFAS substances on health (for example perfluorooctane sulphonate (PFOS) or perfluorooctanoic acid (PFOA)) has led to the establishment of threshold concentrations in certain countries, particularly for drinking water.

Studies on the degradation of PFAS substances are currently in full swing in the scientific community, both academic and industrial. In particular, thermal methods applied to polluted water and ground are being studied.

In addition, one technique being considered, which was initially studied in the water sector, is the HALT (Hydrothermal ALkaline Treatment) method, which is a hydrothermal degradation technique for PFAS compounds. The method envisaged is carried out in a closed reactor, with an increase in both temperature (up to 400 °C) and pressure (up to 25 MPa), in the presence of soda.

However, this method cannot be applied on a large scale, in particular for the following reasons:
the small volume of polluted soil that can be treated in a closed reactor (to build up pressure), which limits the flow rate of the treatment;
the large dose of soda used in the tests presented; and
high cost, particularly compared with other techniques for degrading PFAS substances.

In the case of degradation by incineration, the temperatures required to degrade PFAS substances are generally in the region of 800 °C to 1000 °C.

There is therefore a need for a method to degrade PFAS substances, on a large scale, at low cost and efficiently.

### SUMMARY OF THE INVENTION

The purpose of the present invention is to satisfy this need. It concerns a method for the alkaline-thermal degradation of perfluoroalkyl and polyfluoroalkyl substances (or PFAS substances) present in polluted soil.

According to the invention, said method comprises at least the following steps:
an incorporation step, carried out by at least one incorporation device, to incorporate at least one alkaline compound into the polluted soil;
a heating step, carried out by at least one heating device, to heat the polluted soil comprising the alkaline compound to a so-called degradation temperature, the degradation temperature being between 100 °C and 290 °C, and preferably between 180 °C and 290 °C, and the heating step being carried out at ambient pressure; and
a gas extraction step, implemented by at least one extraction device, to extract the gases generated during the heating step.

In this way, the entire method (and in particular the heating step) is carried out at ambient pressure (i.e. in a non-pressurised environment), with extraction of the gases (generated by degradation and potentially harmful), i.e. without using a closed reactor, which means that there is no limit to the volume of polluted soil treated. Furthermore, surprisingly, the degradation method is particularly effective with a heating step carried out at not particularly high temperatures and with a reduced concentration of alkaline compound, which reduces the cost and facilitates the implementation of the method.

The invention therefore provides a method for degrading PFAS substances on a large scale, at low cost and in an efficient and relatively simple manner (by simple heating at ambient pressure).

In the scope of the present invention, it is meant:
“polluted soil” means soil or any other material, located in particular in the ground or excavated from a site, including water-saturated soil, that is contaminated with PFAS substances; and
“alkaline-thermal degradation” means degradation achieved by both an alkaline action (through the incorporation of an alkaline compound into the polluted soil to be treated) and a thermal action (i.e., heating to a degradation temperature).

In a first embodiment, the incorporation step uses as alkaline compound at least one of the following alkalis: calcium oxide (CaO), calcium hydroxide (Ca(OH)₂).

In a second embodiment, in addition to or as an alternative to the first embodiment, the incorporation step uses as alkaline compound at least one of the following alkalis: sodium hydroxide (NaOH), potassium hydroxide (KOH), sodium hydrogen carbonate (NaHCO₃), potassium oxide (K₂O), sodium oxide (Na₂O). The latter alkalis have the advantage of being more soluble in water than the alkalis of the first embodiment, which simplifies the homogenisation step.

In addition, advantageously, in the incorporation step, the alkaline compound is incorporated in one of the following forms:
in liquid form;
in solid form.

In a particular embodiment, the incorporation step comprises an operation of mixing the polluted soil and the alkaline compound incorporated, in particular when it is incorporated in solid form.

Advantageously, in the incorporation step, the alkaline compound is incorporated into the polluted soil in a proportion of between 0.01 and 0.2 kilograms of alkaline compound per kilogram of polluted soil. In a particular embodiment, the proportion of alkaline compound is between 0.0001 and 0.2 kilograms of alkaline compound per kilogram of polluted soil, i.e. a reduced proportion of alkaline compound.

Furthermore, in a particular embodiment, during the incorporation step, at least one adjuvant for catalysing the degradation reaction is incorporated into the polluted soil. Such an adjuvant is designed, in particular, to react with the degradation by-products of PFAS substances, in order to promote the degradation of the parent compounds by the disappearance of the by-products.

Advantageously, the incorporation step uses as an adjuvant: CaCO₃, MgO, FeO(OH), Fe(OH)₃, Al(OH)₃, ZnCO₃ or aluminium silicates.

In addition, advantageously, the heating step is carried out using a heating device comprising at least some of the following heating elements:
electrically powered heating elements;
heating elements powered by an energy source using a fuel (liquid or gaseous);
heat transfer fluid heating elements.

Furthermore, in a first embodiment, said method is implemented on a treatment site, for example a treatment area (on site or off site) or a treatment centre, to which the polluted soil has been brought during a preliminary step (after its excavation).

Furthermore, in a second embodiment, said method is implemented in situ, i.e., at the location where the polluted soil is located, for example at an industrial site.

Furthermore, in a particular embodiment, the degradation method also comprises a treatment step, implemented by at least one treatment device, to treat the gases extracted in the extraction step. The degradation method can also comprise a control step as described below.

The method also comprises a preliminary step to transport the polluted soil and to set up the devices used to implement the degradation method.

This invention also relates to a system for the alkaline-thermal degradation of perfluoroalkyl and polyfluoroalkyl substances (or PFAS substances) present in polluted soil.

According to the invention, said system comprises in particular:
at least one incorporation device configured to incorporate at least one alkaline compound into the polluted soil;
at least one heating device configured to heat the polluted soil comprising the alkaline compound to a so-called degradation temperature, the degradation temperature being between 100 °C and 290 °C (and preferably between 180 °C and 290 °C) and the heating being carried out at ambient pressure; and

at least one extraction device configured to extract the gases generated during heating by the heating device.

### BRIEF DESCRIPTION OF THE FIGURES

The attached figures will make it clear how the invention may be carried out. In these figures, identical references designate similar elements.

FIG. 1 is a schematic view of a particular embodiment of a degradation system.

FIG. 2 shows a schematic diagram of a particular embodiment of a degradation method.

FIG. 3 is a schematic view of a treatment site at which a degradation method is implemented using a degradation system according to a first embodiment.

FIG. 4 is a schematic view of a site whose ground comprises polluted soil, in which a degradation method is implemented using a degradation system according to a second embodiment.

### DETAILED DESCRIPTION

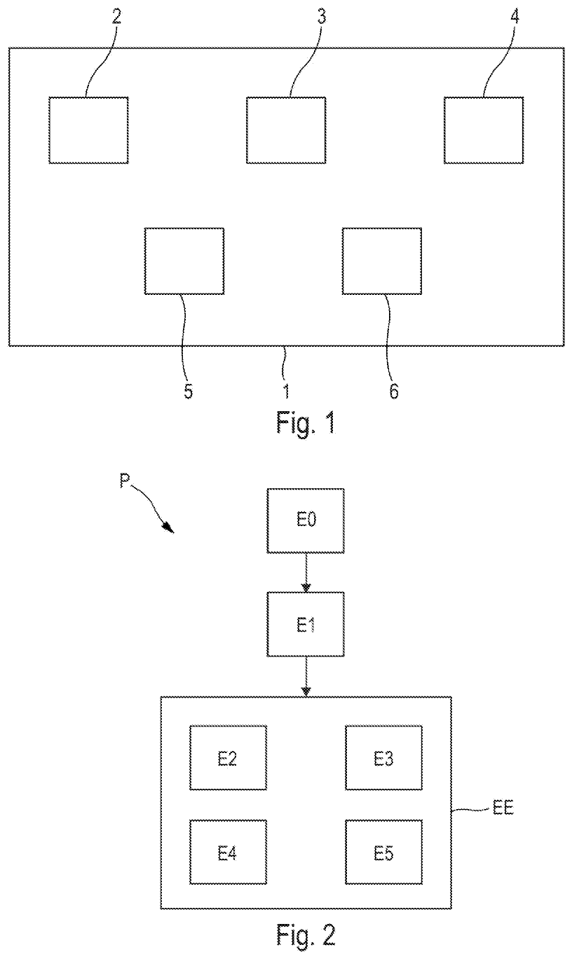

The system 1, illustrating the invention and shown schematically in FIG. 1, is designed to carry out alkaline-thermal degradation of PFAS substances (per- and polyfluoroalkyl substances) present in polluted (or contaminated) soil, for example in polluted ground.

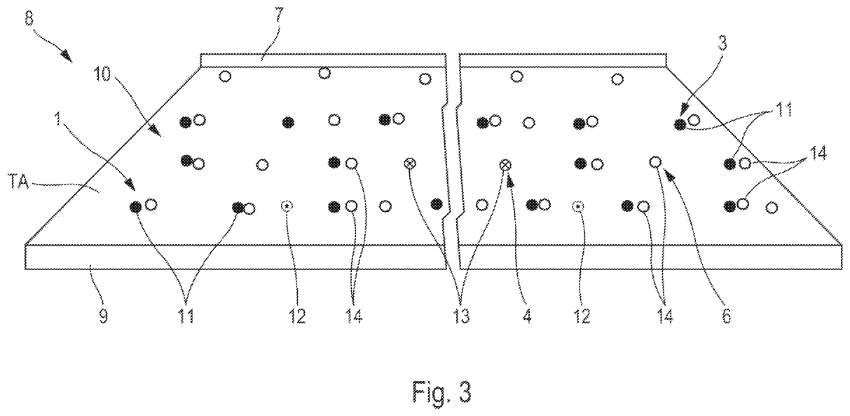

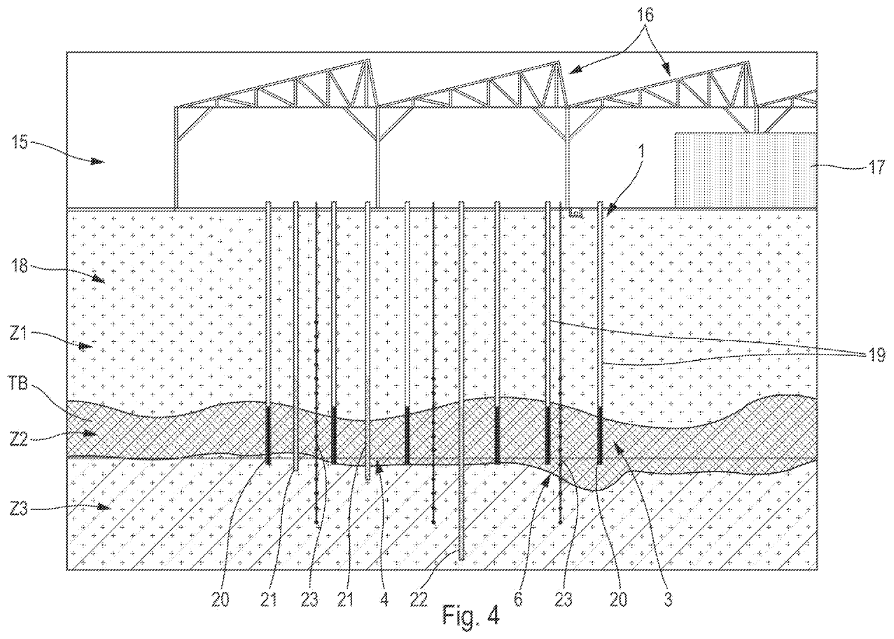

Such polluted soil (contaminated by PFAS substances, which are persistent environmental contaminants), such as polluted soil TA, TB shown in FIGS. 3 and 4, may be present at various types of sites, and in particular industrial sites, fire training sites or sites that have been burned (with the use of foams AFFF), wastewater treatment sites, waste storage or management sites, etc . . .

Generally speaking, the system 1 comprises, as shown very schematically in FIG. 1:
an incorporation device 2 configured to incorporate at least one alkaline compound into the polluted soil TA, TB;
a heating device 3 configured to heat the polluted soil TA, TB comprising the alkaline compound to a so-called degradation temperature. The degradation temperature is between 100 °C and 290 °C (and preferably between 180 °C and 290 °C) and the heating is carried out at ambient pressure; and
an extraction device 4 configured to extract the gases generated during heating by the heating device 3.

The heating device 3 comprises conventional heating elements. Any type of heating element capable of heating the polluted soil to the desired degradation temperature can be used. By way of illustration, the heating device 3 may comprise at least some of the following heating elements:
electrical heating elements comprising, for example, electrical resistors which are supplied with electrical current;
heating elements powered by an energy source using a common fuel (or combustible).

The heat source(s) (electrical, combustible or other) used by the heating device 3 can be used to heat a fluid that is circulated through pipes integrated into the polluted soil.

In addition, in a preferred embodiment, the system 1 also comprises a treatment device 5 for treating the gases extracted by the extraction device 4, as described below.

The system 1 also comprises a control device 6 for monitoring the system 1 and its operation, and in particular for monitoring the temperature in the polluted soil generated by the heating device 3.

The system 1, as described above, is suitable for implementing a method P for the alkaline-thermal degradation of PFAS substances present in the polluted soil.

This method P comprises, as shown in FIG. 2:
an incorporation step E1, carried out by the incorporation device 2, to incorporate at least one alkaline compound into the polluted soil; and
a set EE of steps comprising a plurality of steps E2 to E5, which are implemented (at least in part) simultaneously, and this after the implementation of the incorporation step E1.

This set EE of steps includes, in particular:
a heating step E2, implemented by the heating device 3, to heat the polluted soil (comprising the alkaline compound which was incorporated in the incorporation step E1) to the degradation temperature, at which the polluted soil is heated and maintained throughout this heating step E2; and
an extraction step E3, implemented by the extraction device 4, to extract the gases generated during the heating step E2.

The heating of the polluted soil, combined with the action of at least the alkaline compound, will notably degrade the PFAS substances present in the polluted soil and will produce gases, in particular gases formed (at least in part) by the products generated by the degradation of said PFAS substances. These gases, which may contain harmful substances, are extracted from the polluted soil (at the extraction step E3) to prevent them from being dispersed into the surrounding air. These extracted gases can then be treated in a treatment step E4.

In a particular embodiment, the set EE of steps of the method P (alkaline-thermal degradation) also comprises such a treatment step E4, implemented by treatment device 5, to treat the gases extracted in extraction step E3, as well as a control step E5 specified below.

The method P also comprises a preliminary step E0 designed in particular to prepare the polluted soil to be treated and to set up the various devices of the system 1, so that the set EE of steps can then be implemented.

The various steps of the method P are now described in more detail.

In the incorporation step E1, operators use the incorporation device 2 to incorporate at least one alkaline compound into the polluted soil. In a first embodiment, they incorporate as alkaline compound at least one of the following alkalis: calcium oxide (CaO), calcium hydroxide (Ca(OH)2).

Furthermore, in a second embodiment, in addition to or as an alternative to the first embodiment, in the incorporation step E1, the operators incorporate as alkaline compound at least one of the following alkalis: soda (NaOH), potassium hydroxide (KOH), sodium hydrogen carbonate (NaHCO₃), potassium oxide (K₂O), sodium oxide (Na₂O). The latter alkalis have the advantage of being more soluble in the water than the alkalis of the first embodiment, which simplifies homogenisation.

The proportion (in particular the mass ratio) of alkali incorporated varies according to the type of alkali used and the PFAS concentration in the ground to be treated. In a particular embodiment, the alkaline compound is incorporated into the polluted soil in a proportion of between 0.01 and 0.2 kilograms of alkaline compound per kilogram of polluted soil. In a particular embodiment, the proportion of alkaline compound is between 0.0001 and 0.2 kilograms of alkaline compound per kilogram of polluted soil, i.e. a reduced proportion of alkaline compound.

In this way, a relatively small amount of alkaline compound is sufficient to implement the alkaline-thermal degradation method P, which reduces cost and facilitates implementation.

In a first implementation, the alkaline compound is incorporated in liquid form in the incorporation step E1.

In a particular embodiment, the alkaline compound, for example sodium hydroxide, is dissolved in a liquid, preferably water, and this liquid is then injected into the polluted soil by conventional means (as part of the incorporation device).

The alkaline compound can be injected in this liquid form either by gravity using injection means (wells, drains, etc.) or under pressure via direct injection or using an injection device such as sleeve tubes.

In addition, in a second implementation of this incorporation step E1, the alkaline compound is incorporated in solid form.

To achieve this, one of the following common techniques can be used: in-situ ground mixing, injection of sludge or particulate gel with the solid alkaline compound.

In a particular embodiment, the incorporation step E1 also comprises a mixing operation during which the mixture of polluted soil and alkaline compound incorporated therein is mixed.

This is achieved using conventional mixing techniques. This type of mixing is particularly useful when the alkaline compound is incorporated in solid form.

Whatever the mode of incorporation used, the incorporation device 3 comprises conventional means (not described further) for carrying out this incorporation.

Furthermore, in a particular embodiment, at incorporation step E1, operators also incorporate at least one adjuvant into the polluted soil. The purpose of this adjuvant is to catalyse the degradation reaction taking place in the polluted soil.

Such an adjuvant is designed, in particular, to react with the degradation by-products of the PFAS substances, in order to promote the degradation of the parent compounds by the disappearance of the by-products, and thus promote the alkaline-thermal degradation carried out by the method P.

For example, the adjuvant can be mixed with the alkaline compound when the latter is dissolved in water (or another liquid) for injection in liquid form.

In the case of an adjuvant incorporated in solid form, it can be added and mixed with the alkaline compound (prior to its incorporation) when the latter is incorporated in solid form.

By way of illustration, at least one of the following adjuvants may be used: CaCO₃, MgO, FeO(OH), Fe(OH)₃, Al(OH)₃, ZnCO₃ or aluminium silicates.

However, in a particular embodiment, at least one of the following three adjuvants is preferably used: CaCO₃, MgO and Fe(OH)₃, which are particularly effective.

The proportion (particularly the weight ratio) of adjuvant incorporated varies according to the type of adjuvant used. In a particular embodiment, the adjuvant is incorporated into the polluted soil in a proportion of between 0.005 and 0.1 kilogram of adjuvant per kilogram of polluted soil. In one particular embodiment, the proportion is between 0.0001 and 0.1 kilogram of adjuvant per kilogram of polluted soil.

In the context of the present invention, the entire method P, and in particular the heating step E2, is carried out at ambient pressure. Consequently, no closed device (or reactor) is necessary for implementing method P, which allows for reducing the cost and simplifying the implementation of said method P and, above all, for implementing method P on a large scale, i.e., on large volumes of polluted soil.

As indicated above, the purpose of heating step E2, carried out using heating device 3, is to heat the polluted soil (initially at the temperature of the ground) to the degradation temperature and to maintain the polluted soil at this degradation temperature during the alkaline-thermal degradation method P.

This degradation temperature is between 100 °C and 290 °C, and preferably between 180 °C and 290 °C.

Preferably, the extraction step E3 is implemented as soon as gas is generated by the heating carried out in the heating step E2. At this extraction step E3, the gases generated during the heating step E2 are extracted from the polluted soil.

By way of illustration, in this extraction step E3, which is implemented by the extraction device 4, extraction can be carried out according to one of the following methods:
the gases formed are extracted by suction of the hot air, using a conventional suction system forming part of the extraction device 4;
the gases formed are extracted using a “venting” type process.

Typically, a venting process generally includes the following steps:
an extraction well installation. Wells or pipes are installed in the ground at various depths to allow gas extraction;
the application of pressure or vacuum. Air can be injected into the ground to help displace the gases generated, or a pump can be used to create a vacuum and draw the gases to the surface; and
the extracted gases are collected.

Whatever the extraction method used, the extraction device 4 comprises conventional means (not described further) for carrying out this extraction.

Furthermore, in a particular embodiment, the set EE of steps of the method P (alkaline-thermal degradation) also includes the treatment step E4, implemented by treatment device 5, to treat the gases extracted in the extraction step E3.

The extracted gases are treated to remove contaminants, including by-products generated by the degradation of PFAS substances and possible thermal desorption (volatilisation) of smaller PFAS substances, as well as any other compounds extracted by the increase in temperature (organic matter or other pollutants), before being released into the atmosphere or reused in a particular application.

To do this, by way of illustration, the gases extracted by a “venting” type process are treated by the treatment device 5 depending on the pollutants present in the gas, for example by condensation, oxidation, gas washing or filtration on activated carbon.

Similarly, by way of illustration for gases extracted by hot air extraction, the pollutant vapours are treated by the treatment device 5 which is also adapted to the type of pollutant targeted and which can, for example, implement cooling and condensation of the vapours, washing of the gases or adsorption on activated carbon.

Regardless of the treatment mode used, the treatment device 5 comprises conventional means (not described further) for implementing this treatment.

The gases treated in this way, in which the harmful contaminants have been sufficiently eliminated, can then be released without risk into the atmosphere around the treatment zone. For certain applications, they can also be reused, either immediately or after storage and possibly transport.

Furthermore, in a particular embodiment, the set EE of the method P (degradation) also comprises a control step E5.

The purpose of this control step E5 is to control the method P during its implementation and in particular to measure the temperature of the polluted soil and ensure that it is at the degradation temperature.

To measure the temperature of the polluted soil at the control step E5, the control device 6 may, in particular, comprise thermocouples installed at different points in the polluted soil.

The entire method P (and in particular the heating step E2) is carried out at ambient pressure, with extraction of the potentially harmful gases generated by degradation, i.e. without using a closed reactor, which means that there is no limit to the volume of polluted soil treated. Furthermore, surprisingly, the degradation method P is particularly effective with a heating step E2 carried out at temperatures that are not particularly high (especially compared to the thermal degradation temperature of PFAS substances) and with a reduced concentration of alkaline compounds, which allows for reduced costs and easier implementation of the method P.

Consequently, the system 1 and the method P allow alkaline-thermal degradation of PFAS substances on a large scale, at low cost, and in an efficient and relatively simple manner.

The system 1 and method P, as described above, can be used in a wide range of applications and situations. In particular, they can be implemented in different embodiments, including at different locations. Thus, they can in particular be implemented on a treatment site. They can also be applied in situ, i.e. directly on the site where the polluted soil is located, for example on an industrial site.

In a first embodiment, the method P is implemented (using the system 1) on a treatment site, for example, on an on-site treatment area or in a treatment centre (such as an off-site platform), to which the polluted soil has been brought in a preliminary step E0, after it has been excavated.

In an example of this first embodiment, shown in FIG. 3, the treatment is carried out in a heated stack treatment centre 8.

In this particular example, in the preliminary step E0, the polluted soil TA is excavated in the usual way from the site where it is located and transported to the treatment centre 8. Then, this polluted soil TA is arranged on a waterproof surface 9.

The incorporation step E1 can then be carried out. In this case, the polluted soil TA can, for example, be mixed with the alkaline compound and the adjuvant. The alkaline compound and adjuvant can be applied in liquid or solid form in any of the ways described above.

The stack 10 is then built in the usual way, with the following components:
conventional heating elements 11, shown as black dots in FIG. 3, which form part of the heating device 3;
air injection elements 12, represented by circles with a dot, and air extraction elements 13, represented by circles with a cross, which form part of the extraction device 4; and
thermocouples 14, represented by thick dashed circles, which are for example arranged close to the heating elements 11 and which form part of the control device 6 (to monitor the temperature at control step E5).

Such a stack 10 (covered by a surface element 7) generally has an average size of 500 to 2000 m³. In this way, a very large volume of polluted soil can be treated with a single application of the method P.

The number of heating elements 11 of the heating device 3 and their location and spacing in the stack 10 are determined in particular as a function of the conductivity and heat capacity of the polluted soil TA, as well as the heat source of the heating device 3. The heating elements 11 can be powered by gas (burners), electricity or any other energy source, as indicated above. The heat generated by the heating elements 11 of the heating device 3 in heating step E2 is transmitted to the polluted soil TA by conduction and/or convection and/or irradiation at the hot spots created around the heating elements 11.

In addition, at the extraction step E3, the gases formed are extracted by sucking in hot air via the air extraction elements 13 of the extraction device 4.

These gases (or vapours) containing pollutants are then treated, in the treatment step E4, using a treatment device (not shown), which is adapted to the targeted pollution and which may, for example, implement one of the following usual methods: cooling and condensation of the vapours, washing of the gases or adsorption on activated carbon, etc . . .

In addition, in a second embodiment shown in FIG. 4, the method P is implemented (using system 1) in situ, i.e. on the site 15 where the polluted soil TB is located, for example on an industrial site comprising buildings 16 and installations 17.

In this second embodiment, in preliminary step E0, the ground 18 (containing polluted soil TB) is left in place. In the example shown in FIG. 4, the ground 18 comprises different zones vertically, from top to bottom, namely:
an unsaturated zone Z1;
a zone Z2, in which the polluted soil TB to be treated is located (which may be in a saturated zone and/or unsaturated zone); and
a saturated zone Z3.

In the preliminary step E0, various elements of the system 1 are set up, including:
standard structures 19, equipped with heating elements 20 which are brought into the zone Z2 to be treated. These structures 19 and these heating elements 20 form part of the heating device 3;
gas extraction elements 21 which form part of the extraction device 4 and which are intended to extract gases from the unsaturated zone Z1, and in particular gases generated by the degradation of PFAS substances in the polluted soil TB (or by thermal desorption of low molecular weight PFAS substances or other pollutants), which end up in this unsaturated zone Z;
water extraction elements 22 which end in the saturated zone Z3 and which are intended to extract water from this saturated zone Z3; and
thermocouples 23, which are for example arranged close to some of the heating elements 21, which form part of the control device 6 and which are intended to measure the temperature (in order to be able to monitor the temperature at the control step E5).

In this example, the various elements of the system 1 are installed by drilling.

To do this, these various elements, and in particular the structures 19 of the heating device 3 and the gas extraction elements 21 of the extraction device 4, are placed in the ground 18 as a function of the geology, the target zones to be treated and the accessibility of the site 15.

At the incorporation step E1, the alkaline compound and the adjuvant (prepared in liquid form) can be injected either by gravity via injection means (well, drain, etc.), or under pressure via direct injection or via injection devices, such as sleeved tubes, for example. The incorporation of the alkaline compound and the admixture can also be achieved by means of other injection devices such as in-situ ground mixing, slurry or particulate gel injection, with solid compounds.

In addition, at the extraction step E3, the gases of the ground 18 are extracted by the extraction device 4, for example via a venting process as described above. These pollutant-containing gases (or vapours) are then treated, in the treatment step E4, using a treatment device (not shown) which is adapted to the pollutants present in the extracted gases and which may, for example, implement one of the following usual methods: condensation, oxidation, gas washing, carbon filtration, etc.

The system 1 and the method P, as described above, which implement alkaline-thermal degradation (therefore obtained by heating combined with the addition of an alkaline compound), are particularly effective. In particular, they were tested in the laboratory on polluted soil contaminated with between 1,200 μg/kg and 2,330 μg/kg of twenty PFAS substances:
initially, by thermal desorption at 300 °C without the addition of alkaline compounds, which resulted in reductions in the twenty PFAS substances of 66% after 2 days, 85.6% after 7 days and 92.9% after 20 days; and
in a second phase, with the addition of sodium hydroxide (NaOH) (allowing the polluted soil to reach a pH higher than 13) at 300 °C, the reductions observed were greatly improved, with, after just two days of treatment, 97.2% reduction in the polluted soil, then 99.8% after 7 days and 99.98% after 20 days.

Similar tests were carried out at 260 °C and 250 °C, causing the twenty PFAS substances to volatilize within 48 hours of heating from 23% to 250 °C (control), compared with a reduction of the twenty PFAS substances in just 48 hours of heating of 63% in the presence of NaOH (at 260 °C), 46% in the presence of KOH (at 250 °C), and 45% in the presence of NaHCO₃ (at 250 °C).

1. A method for the alkaline-thermal degradation at ambient pressure of perfluoroalkyl and polyfluoroalkyl substances present in the polluted soil, wherein it comprises at least the following steps:
an incorporation step (E1), carried out by at least one incorporation device (2), to incorporate at least one alkaline compound into the polluted soil (TA, TB), the alkaline compound being incorporated into the polluted soil (TA, TB) in a proportion of between 0.0001 and 0.2 kilograms of alkaline compound per kilogram of polluted soil (TA, TB);
a heating step (E2), carried out by at least one heating device (3), to heat the polluted soil (TA, TB) comprising the alkaline compound to a so-called degradation temperature, the degradation temperature being between 100 °C and 290 °C and the heating step (E2) being carried out at ambient pressure; and
an extraction step (E3), implemented by at least one extraction device (4), to extract the gases generated during the heating step (E2).

2. The method according to claim 1,
wherein the incorporation step (E1) uses as alkaline compound at least one of the following alkalis: sodium hydroxide, potassium hydroxide, sodium hydrogen carbonate, potassium oxide, sodium oxide.

3. The method according to claim 1,
wherein the incorporation step (E1) uses as alkaline compound at least one of the following alkalis: calcium oxide, calcium hydroxide.

4. The method according to claim 1,
wherein in the incorporation step (E1), the alkaline compound is incorporated in one of the following forms:
in liquid form;
in solid form.

5. The method according to claim 1,
wherein in the incorporation step (E1), the alkaline compound is incorporated into the polluted soil (TA, TB) in a proportion of between 0.01 and 0.2 kilogram of alkaline compound per kilogram of polluted soil (TA, TB).

6. The method according to claim 1,
wherein in the incorporation step (E1), at least one adjuvant for catalysing a degradation reaction is incorporated into the polluted soil (TA, TB).

7. The method according to claim 6,
wherein the incorporation step (E1) uses as adjuvant: CaCO₃, MgO, FeO(OH), Fe(OH)₃, Al(OH)₃, ZnCO₃ or aluminium silicates.

8. The method according to claim 1,
wherein the heating step (E2) is carried out using a heating device (3) comprising at least some of the following heating elements (11, 20):
electrically powered heating elements;
heating elements powered by an energy source using a fuel;
heat transfer fluid heating elements.

9. The method according to claim 1, wherein the degradation temperature is between 180 °C and 290 °C.

10. The method according to claim 1, wherein said method (P) is implemented:
on a treatment site (8), to which the polluted soil (TA) has been brought during a preliminary step (E0); or
in-situ.

11. The method according to claim 1,
wherein it comprises a treatment step (E4), implemented by at least one treatment device (5), to treat the gases extracted in the extraction step (E3).

12. A system for the alkaline-thermal degradation of perfluoroalkyl and polyfluoroalkyl substances present in polluted soil,
wherein it comprises:
at least one incorporation device (2) configured to incorporate at least one alkaline compound into the polluted soil (TA, TB), the alkaline compound being incorporated into the polluted soil (TA, TB) in a proportion of between 0.0001 and 0.2 kilogram of alkaline compound per kilogram of polluted soil (TA, TB);
at least one heating device (3) configured to heat the polluted soil (TA, TB) comprising the alkaline compound to a so-called degradation temperature, the degradation temperature being between 100 °C and 290 °C and the heating being carried out at ambient pressure; and
at least one extraction device (4) configured to extract the gases generated during heating by the heating device (3).
